(19) United States
(12) Patent Application Publication
(10) Pub. No.: US 2003/0064872 A1
(43) Pub. Date: Apr. 3, 2003

(54) Optical analysis disc and related drive assembly for performing interactive centrifugation

(76) Inventors: Mark Oscar Worthington, Irvine, CA (US); Andrew Attila Pal, Rancho Santa Margarita, CA (US)

Correspondence Address: J. D. Harriman II, COUDERT BROTHERS LLP, 23rd Floor, 333 South Hope Street, Los Angeles, CA, 90071, US

(21) Appl. No.: 10/201,591

(22) Filed: Jul. 22, 2002

Related U.S. Application Data
(60) Provisional application No. 60/306,678, filed on Jul. 20, 2001.
(60) Provisional application No. 60/306,703, filed on Jul. 20, 2001.

(51) Int. Cl. B04B 9/10

(52) U.S. Cl. 494/37; 494/1; 494/9; 436/177

(57) ABSTRACT

The present invention is a method and software for interactively centrifuging biological samples on bio-discs in computer disc drives. A bio-disc is a modified disc that can store laboratory samples. The software initializes the disc drive rotational speed and then monitors the response from the disc. The disc drive directs the laser at the disc and detects light that has interacted with laboratory samples on disc. This detection is used for recognition of the current state of the biological samples. One embodiment detects responses from the interrogation to adjust the rotational speed of the disc during the centrifugation process. The present invention takes advantage of existing speed control commands in constant linear velocity (CLV) and constant angular velocity (CAV) drives to achieve a wide range of rotational speeds. Another embodiment of the invention includes agitation of the disc which facilitates the separation of the biological samples.

### RELATED APPLICATION

The applicant claims priority to provisional patent application No. 60/306,678 filed on Jul. 20, 2001.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates in general to interactive centrifugation in computer optical disc drives associated with testing biological, chemical, or biochemical samples. More specifically, but without restriction to the particular embodiments hereinafter described in accordance with the best mode of practice, this invention relates to methods and software for periodically adjusting the disc drive rotational speed to optimal speeds during the operation of optical disc centrifugation using bio-discs.

2. Background Art

A number of research and diagnostic situations require the use of centrifugation, which is used to accelerate the sedimentation of precipitates and particulates of biochemical protocols. Sedimentation of a biological sample is achieved when the sample is spun at its specific sedimentation velocity. Sedimentation velocity is a measure of how fast a component will migrate through other more buoyant sample components as a result of the centrifugal field generated by the centrifuge. Different biological samples undergo sedimentation at different velocities because each component has a different density and thus a different sedimentation velocity.

A drawback of a standard centrifugation system is that the sample cannot be analyzed to interactively check if the sample is being spun at its specific sedimentation velocity during the centrifugation process. In a standard centrifugation system, the user spins the sample at a designated rotational speed for a specific amount of time and then stops the centrifugation process to check the state of the sample at that point. This is a time consuming process, as prior art centrifuges require that the sample (often contained in a test tube) be locked into the centrifuge to prevent possible accidental contamination by the spilling of a spinning fluid sample. Thus, the interruption of a centrifuge cycle involves stopping the centrifuge, waiting till it spins down to a stop state. Unlocking access to the sample holding area, retrieving the test tube or sample holder of the sample of interest, checking the sample to see if acceptable sedimentation has taken place, and reinserting the sample and locking it in if more centrifugation is required.

According to the state of the sample, the user might then spin the sample at the same or another designated rotational speed for a specific amount of time. The sample might then need to be checked again for acceptable sedimentation going through the procedure outlined above. This process can become very iterative and lengthy in time.

To avoid this iterative process in a standard centrifugation environment, the prior art sometimes determines a “worst case scenario” of the fastest speed and longest time required to fully centrifuge a sample that has variable sedimentation velocities, depending on its composition. A disadvantage of such a system is unnecessary centrifugation for samples that are not in the worst case scenario, wasting time and resources. Another disadvantage is damage to the sample from over centrifuging if the sample had achieved acceptable sedimentation already and yet was subjected to additional centrifugation. This can be a problem when the samples to be separated are subject to destruction from excessive force.

### SUMMARY OF THE INVENTION

The present invention relates in general to performing interactive centrifugation using disc drive assemblies. It relates to controlling a disc drive assembly to facilitate centrifugation of biological, chemical, or biochemical samples. More specifically, but without restriction to the particular embodiments hereinafter described in accordance with the best mode of practice, this invention relates to methods and software for interactively modifying the rotational speed of an existing disc drive to create an optimal interactive disc centrifuge.

The present invention is also directed to bio-discs, bio-drives and related methods. This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Serial No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Bio-discs with Reflective Layers” filed on Nov. 15, 2001; U.S. patent application Ser. No. 09/988,728 entitled “Methods And Apparatus For Detecting And Quantifying Lymphocytes With Optical Biodiscs” filed on Nov. 20, 2001; U.S. patent application Ser. No. 09/988,850 entitled “Methods and Apparatus for Blood Typing with Optical Bio-discs” filed on Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory And Improved Optical Bio-Disc Including Same” filed Dec. 14, 2001; U.S. patent application Ser. No. 10/035,836 entitled “Surface Assembly For Immobilizing DNA Capture Probes And Bead-Based Assay Including Optical Bio-Discs And Methods Relating Thereto” filed Dec. 21, 2001; U.S. patent application Ser. No. 10/038,297 entitled “Dual Bead Assays Including Covalent Linkages For Improved Specificity And Related Optical Analysis Discs” filed Jan. 4, 2002; U.S. patent application Ser. No. 10/043,688 entitled “Optical Disc Analysis System Including Related Methods For Biological and Medical Imaging” filed Jan. 10, 2002; and U.S. Provisional Application Serial No. 60/348,767 entitled “Optical Disc Analysis System Including Related Signal Processing Methods and Software” filed Jan. 14, 2002. All of these applications are herein incorporated by reference in their entireties. They thus provide background and related disclosure as support hereof as if fully repeated herein.

### BRIEF DESCRIPTION OF THE DRAWINGS

These and other features, aspects and advantages of the present invention will become better understood with regard to the following description, appended claims and accompanying drawings where:

FIG. 1 is a pictorial representation of a bio-disc system according to the present invention.

FIG. 2 is a detailed pictorial representation of the interior of a bio-disc player assembly according to an embodiment of the present invention.

FIG. 3 is a flow chart which shows an overview of the main steps for the process of interactive optical disc drive centrifugation.

FIG. 4 is a flow chart which depicts the general steps that a user would perform to execute the interactive optical disc centrifuge.

FIG. 5 is a flow chart which depicts the detailed steps of the process of interactive optical disc centrifugation.

FIG. 6 is a flow chart showing the sub-steps involved in the “initialization of the software” step of FIG. 3 and FIG. 5.

FIG. 7 is a pictorial depiction of the user interface for the software.

### DETAILED DESCRIPTION OF THE INVENTION

The present invention is a method and software for utilizing a computer disc drive as an interactive centrifuge. One embodiment of the present invention takes advantage of embedded command sets which are present in computer disc drives. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Interactive centrifuging is accomplished by checking for qualifying responses during the centrifuging process, and based on these responses the disc drive speed is adjusted accordingly. The present invention may be readily applied to centrifuging any type of cellular matter. This can include, but is not limited to, red blood cells, white blood cells, beads and any other objects, both biological and non-biological, that produce similar optical signatures that can be detected by an optical reader.

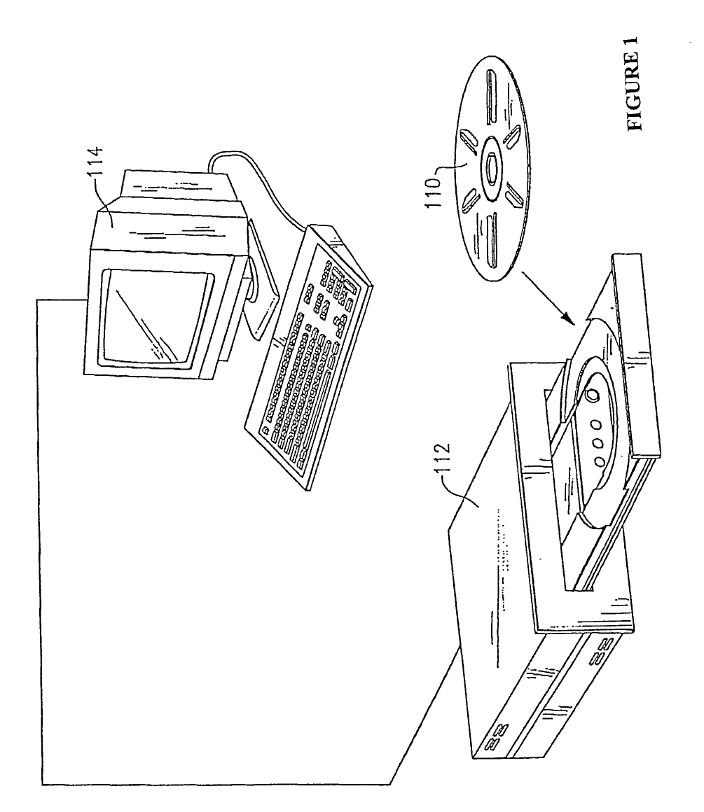

Embodiments of the present invention involve the interactive centrifuging of cellular matter in laboratory samples. FIG. 1 is a perspective view of a bio-disc 110 according to the present invention. The present bio-disc 110 is shown in conjunction with a disc drive 112 and a display monitor 114. Test samples are deposited onto designated areas on bio-disc 110. Once the bio-disc is inserted into optical disc drive 112, the disc drive is responsible for collecting information from the sample through the use of electromagnetic radiation beams that have been modified or modulated by interaction with the laboratory samples. After the information is analyzed and processed, computer monitor 114 displays the results. More specifically, once the samples are deposited into designated fluid channels of the optical bio-disc, the bio-disc is inserted in a bio-disc drive. The disc is spun inside the drive, with the spinning controlled by software in the present invention to provide interactive centrifugation. The disc has places where the laser beam can interact with the sample and a response is generated by the drive when it detects the returning beam.

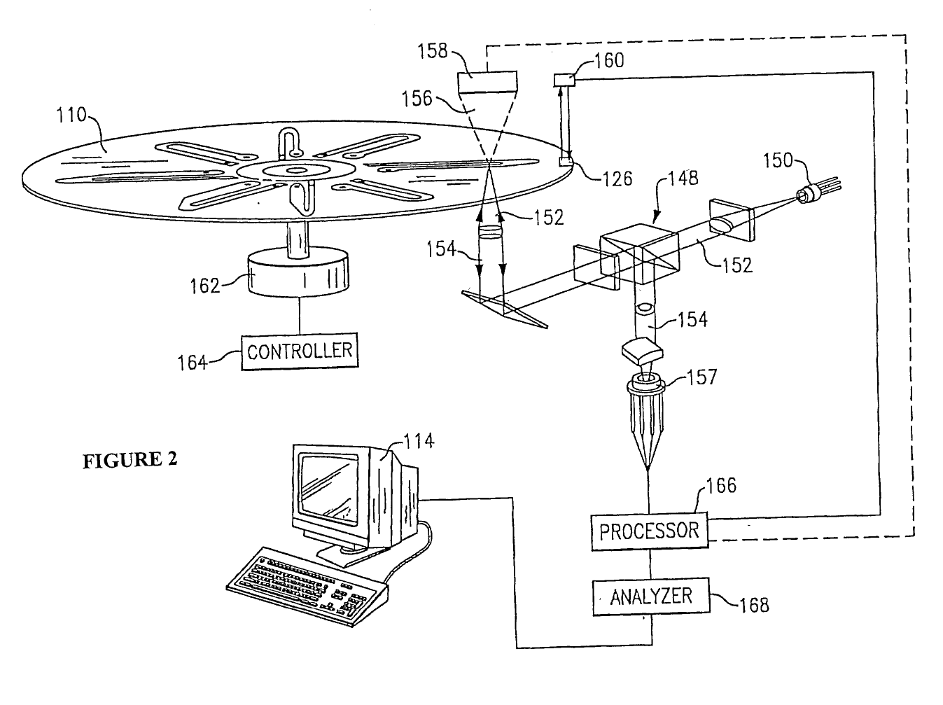

FIG. 2 is a diagram illustrating the operation of the interior of the disc drive. It shows component 148, a light source 150 that produces the incident or interrogation beam 152, a return beam 154, and a transmitted beam 156. In the case of the reflective type of bio-disc, the return beam 154 is reflected from the reflective surface bio-disc 110. The reflective bio-disc reflects all light that is directed onto the disc. In the reflective optical bio-disc 110, the return beam 154 is detected and analyzed for the presence of signal agents by a bottom detector 157. In the transmissive bio-disc embodiment, portions of the light directed at the disc is allowed to pass through the disc. The present invention also accommodates a transmissive bio-disc embodiment, wherein transmitted beam 156 is detected by a top detector 158 and is also analyzed for the presence of signal agents. In the transmissive embodiment, a photo detector may be used as a top detector 158.

FIG. 2 also shows a hardware trigger mechanism that includes the trigger markings 126 on the disc and a trigger detector 160. The hardware triggering mechanism is used in both reflective bio-discs and transmissive bio-discs. The triggering mechanism allows the processor 166 to collect data only when the interrogation beam 152 is on a capture zone 140. In the transmissive bio-disc system, a software trigger may also be used. The software trigger uses the bottom detector to signal the processor 166 to collect data as soon as the interrogation beam 152 hits the edge of a capture zone. FIG. 2 also illustrates a drive motor 162 and a controller 164 for controlling the rotation of the optical bio-disc 110. FIG. 2 further shows the processor 166 and analyzer 168 implemented in the alternative for processing the return beam 154 and transmitted beam 156 associated the transmissive optical bio-disc. In the case of the transmissive optical bio-disc, the transmitted beam 156 carries the information about the biological sample. In this embodiment, there is pre-recorded information on disc. Detector 158 collects the beam. The detector then sends the detected beam intensity as a analog signal to a signal processor 166 where the analog signal is sampled at discrete time intervals and a digital reproduction is created. The sampling rate determines the number of times a digitized signal is taken from an analog signal. The operation of the drive and related bio-disc embodiments is more fully described in co-pending U.S. patent application Ser. No. 10/006,371, entitled “Methods for Detecting Analytes Using Optical Discs and Optical Disc Readers” filed Dec. 10, 2001.

Disc Implementation

A bio-disc is similar in structure to the CD, CD-R, CD-RW, DVD, or equivalent discs that are widely available in the market today. Like these commonly available embodiments, each bio-disc has tracks that wind around the center of the disc from the interior edge to the exterior edge. Each track is defined by either a wobble groove or pits and lands, where pits are depressed areas along the track and lands are the areas that are not depressed. The wobble groove or the combination of pits and lands, alters the way the incident laser beam is reflected as it moves along the track. The change in reflectivity results in the signal pattern generated by the reflected beam which in turn represents encoded data. In addition to having these common disc features, the bio-disc also has fluidic channels to house laboratory samples and necessary chemical solutions, triggering mechanisms to initiate the reading of samples and other features designed for conducting biological analysis. The bio-disc may include encoded information for performing, controlling, and post-processing the test or assay. For example, such encoded information may be directed to controlling the rotation rate of the disc. Depending on the test, assay, or investigational protocol, the rotation rate may be variable with intervening or consecutive sessions of acceleration, constant speed, and deceleration. These sessions may be closely controlled both as to speed and time of rotation to provide, for example, mixing, agitation, or separation of fluids and suspensions with agents, reagents or antibodies. The methods of the present invention may thus be advantageously implemented on such modified optical disc or bio-disc.

Drive Implementation

A bio-disc drive assembly may be employed to rotate the disc, read and process any encoded information stored on the disc and analyze the DNA or other samples in the flow channel of the bio-disc. The bio-disc drive is thus provided with a motor for rotating the bio-disc, a controller for controlling the rate of rotation of the disc, a processor for processing return signals form the disc and an analyzer for analyzing the processed signals. The rotation rate of the motor is controlled to achieve the desired rotation of the disc. The bio-disc drive assembly may also be utilized to write information to the bio-disc either before or after the test samples in the flow channels and target zones are interrogated by the read beam of the drive and analyzed by the analyzer. The bio-disc may include encoded information for controlling the rotation rate of the disc, providing processing information specific to the type of DNA test to be conducted, and for displaying the results on a monitor associated with the drive in accordance with the processing methods of this invention.

Interactive Optical Disc Centrifuge Overview

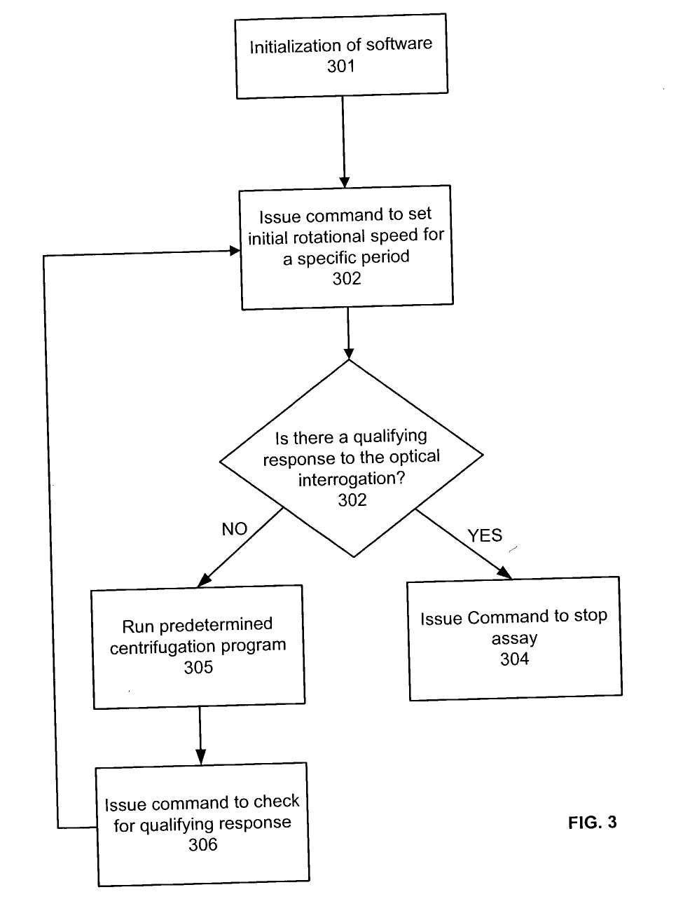

FIG. 3 illustrates an overview of the interactive optical disc drive centrifugation process. The first step of the process, step 301, involves the initialization of the software. The user initiates this step by running the software. Once the software begins running, the software decides which command sets to use to interface with the disc drive and subsequently sends commands to start the disc drive spinning at a designated initial rotational speed for a specific period (step 302). The next step of the process, step 303, involves monitoring the response from the disc being centrifuged. After the specified period has elapsed, the software determines whether there are any qualifying responses to the interrogation of the sample. In common disc drives, the drive generates responses to various conditions as it reads the disc. By monitoring these responses, the software can determine whether they qualify for the conditions sought by the current assay being performed. Some methods of determining responses are described in the related patents, patent applications and provisional patent applications described above. If the software decides that there is a qualifying response, the process proceeds to step 304. In step 304, the software issues commands to stop the assay that is being performed. Note that if the software decides that there is not a qualifying response present, the process will proceed directly to step 305. In step 305, the software will run a predetermined centrifugation program. This program will determine, depending upon the types and intensities of responses that are observed, how to adjust the drive rotational speed accordingly. The program may determine to adjust the speed to be faster or slower than the previously used speed setting. Agitation of the sample is also an option that the program may determine to initiate. The program also determines the period that the sample should be spun at this newly designated speed. This spinning period can be a either a specified period of time or simply the number of rotations that the sample is to be spun. After the disc drive has spun for the specified period, the software issues a command to check for qualifying responses (step 306). The software will then determine whether a qualifying response has occurred (step 303). The process then continues in the same manner as described above.

User Operation of the Interactive Optical Disc Centrifuge

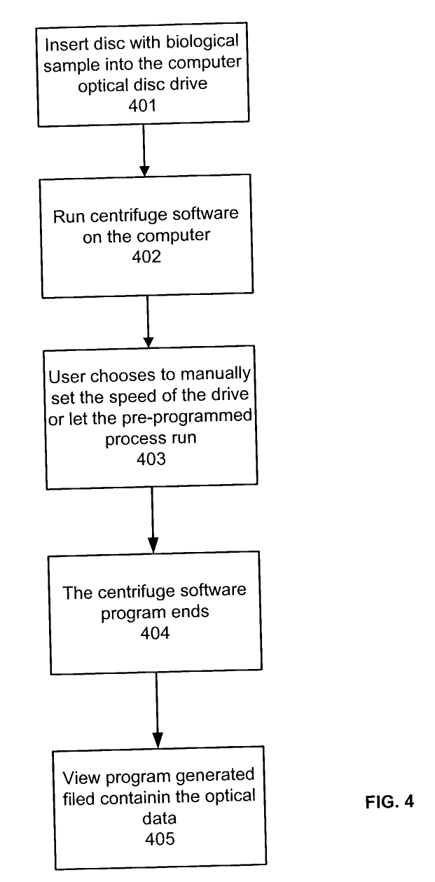

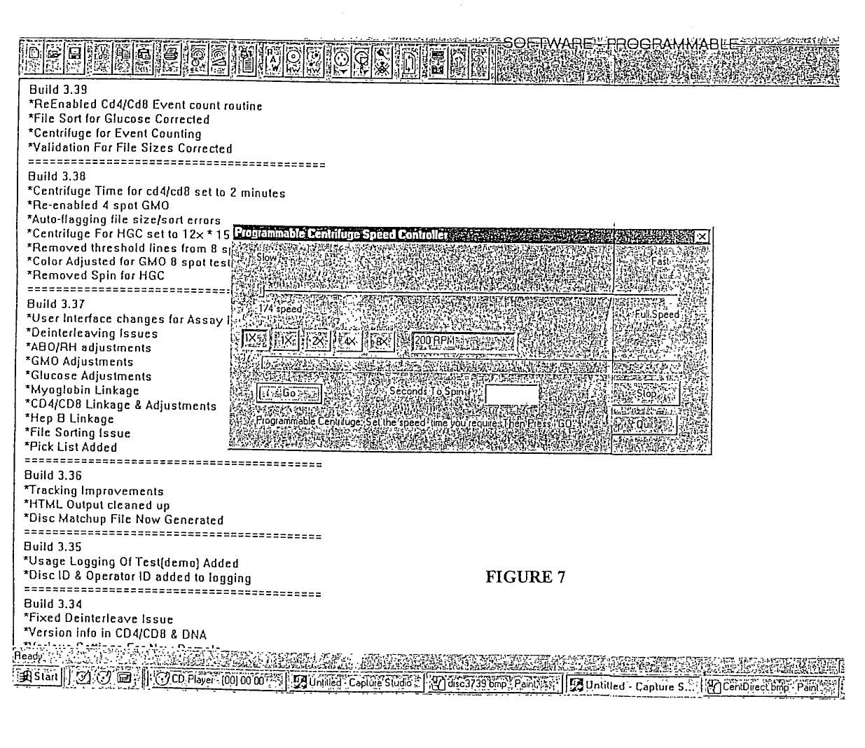

FIG. 4 depicts the few steps needed to show how a user operates the interactive optical disc centrifuge. The first step, step 401, involves the user inserting a disc with a biological sample into the disc drive. In the next step, step 402, the user starts the interactive centrifuging process by running the centrifuging software program. The software will then prompt the user with the option of either manually setting the speed of the drive and the period of time for spinning (as depicted in FIG. 7) or letting the pre-programmed centrifuging process run (step 403). The software can also be configured to prompt the user to issue an agitation command to the disc drive. If the pre-programmed centrifuging process is chosen, the length of time of the centrifuging process will vary according to the type of assays being performed. In the next step, step 404, the centrifuging software program ends. After the program ends, the user is able to observe the results of the centrifugation process (step 405). Depending upon how the centrifugation software is configured, the user can view the optical data results directly on the computer screen and/or by opening a program generated file.

Interactive Optical Disc Centrifuge Detailed Steps

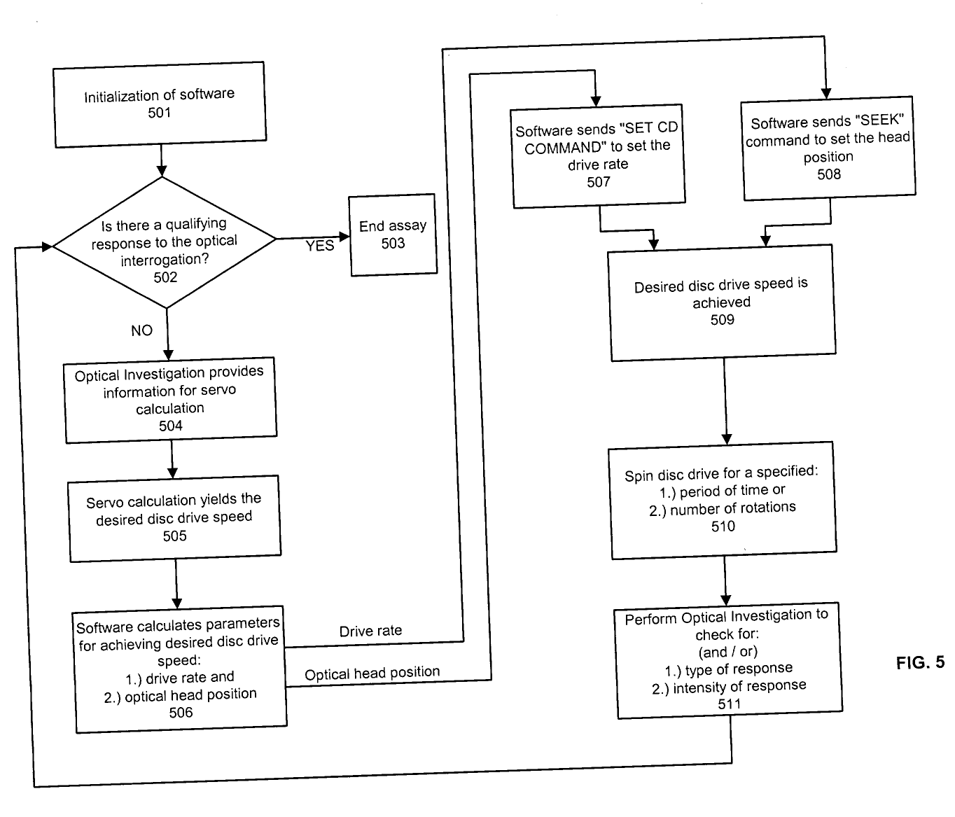

FIG. 5 is a flowchart illustrating in detail the operation of the present invention. At the first step, step 501, the software is initialized. This step involves the user running the centrifugation software which causes the disc drive to spin at an initial rotational speed for a predetermined period. The next step of the process, step 502, involves monitoring the progress of the centrifugation process by using software detection of qualifying responses to the interrogation. After the initial centrifuge process, the software determines whether there is a qualifying response present.

If the software determines that there is a qualifying response to the interrogation, the assay ends (step 503). However, if the software determines that there is no qualifying response to the optical interrogation, the centrifugation process proceeds to step 504. In step 504, the investigation of the disc provides information for calculating a servo response that results in an optimized centrifuging condition. The software, by using the optical investigation data, calculates an optimal disc drive rotational speed (step 505). After the desired disc drive speed is determined, the software calculates two parameters, drive rate or optical head position, that are required to achieve the desired rotational speed (step 506). Before the description of steps 507 and 508, background information on the calculation of the rotational speed parameters of the optical disc is described below.

Disc-Logic Controlled Centrifuge Device

The rotational speed of constant linear velocity disc drives is achieved by controlling the drive rate and optical head position. Most optical disc drives operate at a constant linear velocity (CLV). This means that the, linear velocity of the disc relative to the optical head is constant for a given disc drive rate (1×, 2×, etc.) and at all radial positions. Essentially the drive adjusts the angular velocity, or rotational speed (rev/min), of the disc as a function of the head's position so as to maintain a given linear velocity. The given linear velocity depends on the current drive rate (1×, 2×, etc.). For example, a 1× drive spins the disc at a constant linear velocity of 1.2 m/s relative to the optical head. All other drive rates are simple multiples of this base value:

| Drive Rate | Linear Velocity (m/s) |
|---|---|
| 1x | 1.2 |
| 2x | 2.4 |
| 4x | 4.8 |
| 8x | 9.6 |
| 16x | 19.2 |

To maintain a given linear velocity L (m/s) at a radial position r (mm), the drive spins the disc at a rotational speed of (30,000*L)/(Π*r) revolutions per minute, where r is equal to the distance between the disc center and the optical head. The device performs this logic automatically as part its circuitry. Thus, by simply selecting a drive rate and moving the drive head to a calculated position, the drive is capable of a range of rotational speeds. However, the range is limited by not only the drive rates available, but also the range of the optical head movement. For optical disc drives that are within industry specifications, this range is 25 mm to 58 mm. Thus, the available rotational speeds for a 16×drive, for example, would be:

| Drive Rate | Linear Velocity (m/s) | Rotational Speed Range (rpm) |
|---|---|---|
| 1x | 1.2 | ˜197.57 to ˜458.37 |
| 2x | 2.4 | ˜395.14 to ˜916.73 |
| 4x | 4.8 | ˜790.29 to ˜1833.47 |
| 8x | 9.6 | ˜1580.57 to ˜3666.93 |
| 16x | 19.2 | ˜3161.15 to ˜7333.86 |

Note that because there is overlap in the rpm ranges between drive rates, by setting the drive rate and optical head position, a range of 197.57 rpm to 7333.86 rpm can be achieved for this example drive.

Interactive Optical Disc Centrifuge Detailed Steps (Continued)

Once the software calculates the drive rate and optical head position required for the desired disc speed (step 506), the software issues commands to the disc drive to set the drive rate (step 507) and the head position (step 508) to those calculated specifications. The drive rate is set through the standard SCSI or ATAPI drive command “SET CD SPEED” (step 507). The command actually takes a parameter that describes the desired data rate passing the optical head in Kbytes/sec. The software easily calculates this value by looking up the specified drive rate on a lookup table in its database. The head is positioned using the standard drive command “SEEK” (step 508). This command takes its position parameter as a Logical Block Address (LBA), which must be calculated from the desired position in millimeters. The software calculates the LBA parameter by using this equation:

$$LBA = ( 75 \text{frames/sec} ) \times \frac{Π ( {( r \text{mm} )}^{2} - {( 25 \text{mm Inner Radius} )}^{2} )}{( 1.6 \text{µm trackpitch} ) ( \text{linear velocity} \times \text{meters/sec} )}$$

Once the drive rate and head position are set, the desired disc drive speed is achieved (step 509).

However, it should be noted that some disc drives operate at a constant angular velocity (CAV). These disc drives spin at a set rpm speed regardless of the laser head position on the disc. Thus, if the laser head is located on the outer-edge of the disc verses being located on the inner-edge of the disc, there is more surface area being scanned and the data is being transferred at a higher rate. To take this operating characteristic into account, if a CAV disc drive is being used with this software, the centrifuging process will send commands to directly set the disc drive to the desired disc drive rotational speed, without using head position as a parameter.

Once the desired drive speed is achieved, the software will allow the disc drive to spin for either a specified period of time or number of rotations, depending upon how the software is configured (step 510). Note that user intervention is also possible by that the user may choose forgo the pre-programmed centrifugation process and manually set the rpm speed of the drive and the period of time for the spinning (refer to step 403). In the next step, step 511, an investigation is performed which checks for certain types of responses and/or intensity of responses. The process then proceeds to step 502 where the software determines whether there is a qualifying response. The process then continues in the same manner as described above.

Initialization of the Software

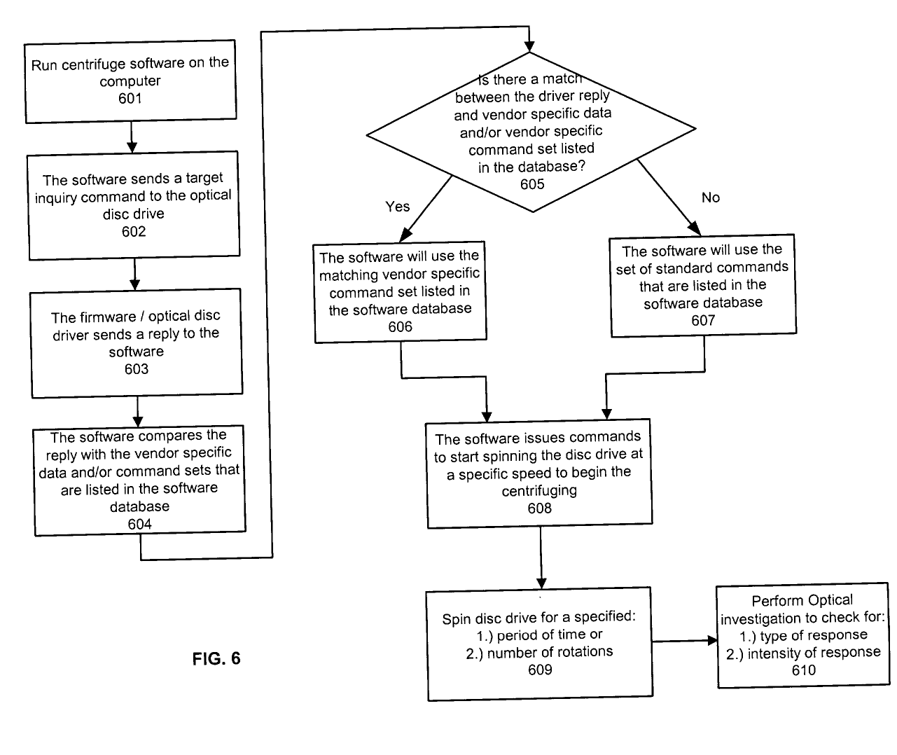

FIG. 6 depicts the sub-steps that are involved with the “initialization of the software” step that is in FIG. 3 and FIG. 5. In the first step, step 601, the user begins the centrifuging process by running the software on the computer. Once the software begins to run, the software sends a target inquiry command to the optical disc drive of the computer (step 602). The target inquiry command is requesting information about the manufacturer, firmware version, and specifications of the disc drive. In the next step, step 603, the optical disc drive sends a reply, which consists of all of the functions of the drive, to the software. The software then compares the reply with the vendor specific data and/or command sets that are listed in a software database which is coupled with the software (step 604). In step 605, the software determines whether there is a match with the driver reply and vendor specific data and/or a vendor specific command set listed in the software database. If the software determines that there is a match, the software will utilize the matching vendor specific command set to interface with the optical disc drive (step 606). Otherwise, the software will just use the default set of standard commands that are listed in the software database to interface with the optical disc drive (step 607). For example, the Multi-Media Command (MMC) set is an industry standard which can be used as a default command set. In the next step, step 608, the software will issue commands, from the database that it has determined to use, to the optical disc drive to start spinning at a specific initial rotational speed to begin the centrifuging. After the disc has spun for a specified period or time or number of rotations (step 609), the software will issue commands where an optical investigation checks for types of responses and/or intensity of the responses, depending upon how the software is configured (step 610). The centrifuging process then proceeds according to the following steps on FIG. 3 and FIG. 5.

It should be noted that when head position is used as a method of speed control, it may be necessary to position the sample to be examined and/or interrogated at a location at which the head position is such that a desired initial centrifuge rate is achievable. When higher or lower rotation speeds are required based on status of qualifying responses, the head position can be moved to another radial location to determine the rotation speed and then returned to the sample location for investigation of qualifying responses.

Agitating the Biological Sample on the Disc

Sometimes it is necessary during the course of an assay to agitate the biological sample on the disc. Agitation provides an additional amount of torque on the biological sample to facilitate mixing, separating, or a chemical reaction. In an alternate embodiment of this invention, the disc drive can be used as an agitator. By rapidly alternating the rotational speed, the acceleration and deceleration will provide enough forces for agitating the sample. For example, in order to achieve agitation, the disc can be initially spun at 1× speed, then at 4× speed, and then returning to 1× speed. This embodiment can also include an investigation (similar to step 511) after the agitation takes place in order for the software to determine if a qualifying response has occurred.

Qualifying Responses

In common disc drives, the drive generates responses to various conditions as it reads the disc. For example, if the laser power detected is too low, the disc drive may compensate for this by boosting the laser power. Or in another example, if the reflected laser is detected to be off track, the tracking mechanism will compensate by moving the laser head to correctly track the disc. Qualifying responses for the interactive optical disc centrifuge can be defined to be many different things, depending upon the assay being performed during the centrifugation. Typical responses can be found in operational mechanisms such as speed control, focal and tracking position, objective assembly positioning, signal gain correction, etc. By monitoring these responses, the software can determine whether they qualify for the conditions sought by the current assay being performed. For example, if the current assay is looking for a condition of opacity in the sample, then the qualifying response could be a signal gain detection because this type of response could indicate that a lower power has been detected. Thus, the present invention takes advantage of existing operational mechanisms of the disc drive for determining qualifying responses.

Other methods of detecting qualifying responses include analysis techniques described in the patents, patent applications, and provisional patent applications described above and incorporated herein by reference.

One technique contemplated by the present invention is the storing of digital data on the nonsample of the areas of the disk that produce digital silence, white noise, pink noise, or some other recognizable and/or consistent pattern. Any variation of this background as a result of sample behaviour can be easily detected as an anomaly in the received data. Discs configured with these patterns can then be used to generate a response table that is stored in a database. When an interrogation is performed, results can be quickly compared to the response table to identify variations that might represent qualifying responses. One technique is to use C1 and C2 to identify possible qualifying responses.

Conclusion

Thus a method and software for interactive centrifuging of biological samples using disc drives is described in conjunction with one or more specific embodiments. While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention. The invention is defined by the claims and their full scope of equivalents.

We claim:

1. A method of performing interactive centrifugation, said method comprising the steps of:
spinning a disc having a biological sample in a disc drive at a specified initial speed;
checking interactively for a qualifying response from said disc drive; and
spinning said disc following a predetermined progam when a qualified response is not received.

2. The method of claim 1 wherein said step of checking interactively further comprises the steps of:
performing an investigation to check for said qualifying responses;
analyzing information from said responses.

3. The method of claim 2 further comprising the steps of:
calculating the drive rate for achieving said desired disc drive rotational speed;
issuing command to set said drive rate;
spinning said disc drive for a specified period;
performing an investigation to check for qualifying responses; and
determining whether a qualifying response has been received.

4. The method of claim 2 further comprising the steps of:
calculating a head position for achieving said desired disc drive rotational speed;
issuing command to set said head position;
spinning said disc drive for a specified period;
performing an investigation to check for responses; and
determining whether a qualifying response has been received.

5. The method of claim 1 wherein said specified speed is manually chosen by user.

6. The method of claim 1 wherein said specified speed is set by said software.

7. The method of claim 1 wherein said step of setting said initial speed comprises the steps of:
sending a target inquiry command to said disc drive;
receiving a reply from said disc drive; and
checking said reply against a list of vendor data in a database.

8. The method of claim 7 wherein said step of setting said initial speed further comprises the steps of:
using vendor specific commands from said database if said reply is found in said database;
issuing said vendor specific commands to spin said disc drive at a specific rotational speed for a specified period.

9. The method of claim 7 wherein said step of setting said initial speed further comprises the steps of:
using standard commands from said database if said reply is not found in said database;
issuing said standard commands to spin said disc drive at a specific rotational speed for a specified period.

10. The method of claim 1 wherein said step of spinning said disc spins said disc drive at different speeds to achieve the effect of agitation.

11. The method of claim 1 wherein said disc drive is a CLV disc drive and said speed is set by moving a read head to a radial position so as to result in a desired rotation speed.

12. The method of claim 1 wherein said disc drive is a CAV drive and said speed is set by providing speed control commands to said disc drive.
